(19) United States
(12) Patent Application Publication
(10) Pub. No.: US 2023/0278560 A1
(43) Pub. Date: Sep. 7, 2023

(54) SYSTEMS AND METHODS TO USE TIRE CONNECTIVITY FOR POWERTRAIN EFFICIENCY

(71) Applicants: Cummins Inc., Columbus, IN (US); Compagnie Generale Des Etablissements Michelin, Clermont-Ferrand (FR)

(72) Inventors: Hoseinali Borhan, Bloomington, IN (US); Jingxuan Liu, Columbus, IN (US); Bibin N. Pattel, Columbus, IN (US); Robert Ciprian Radulescu, Greenville, SC (US)

(73) Assignees: Cummins Inc., Columbus, IN (US); Compagnie Generale Des Etablissements Michelin, Clermont-Ferrand (FR)

(21) Appl. No.: 18/315,822

(22) Filed: May 11, 2023

Related U.S. Application Data
(63) Continuation of application No. PCT/US21/58880, filed on Nov. 11, 2021.
(60) Provisional application No. 63/112,700, filed on Nov. 12, 2020.

(51) Int. Cl. B60W 30/165; B60W 30/14; B60W 10/18; B60W 40/068; B60W 60/00; B60T 7/22

(52) U.S. Cl. CPC B60W 30/165; B60W 30/143; B60W 10/18; B60W 40/068; B60W 60/001; B60T 7/22; B60W 2530/20; B60W 2552/40; B60W 2554/802; B60W 2554/804; B60W 2556/65; B60T 2210/12; B60T 2201/022

(57) ABSTRACT

A method of operating an electronic control system of a vehicle includes determining a first braking distance to achieve a first speed of a first vehicle, receiving a second vehicle braking distance to achieve a second vehicle speed of a second vehicle forward of the first vehicle, determining a minimum following distance between the first vehicle and the second vehicle in response to the first braking distance and the second braking distance, and controlling operation of the vehicle with an autonomous control system using the minimum following distance. A computer-implemented fleet management system is configured to receive logistics objectives including load, timeline, and cost information for a freight delivery, receive fleet information including tire parameters of a plurality of vehicles of a fleet, and determine a plurality of trips and a corresponding vehicle selection in response to the logistics objectives and the fleet information.

### CROSS-REFERENCE

The present disclosure claims the benefit of and priority to U.S. Application No. 63/112,700 filed Nov. 12, 2020, which is hereby incorporated by reference.

### GOVERNMENT RIGHTS

This invention was made with Government support under award number DE-EE0008469 awarded by the United States Department of Energy. The Government has certain rights in this invention.

### BACKGROUND

The present disclosure relates to systems and methods to use tire connectivity for powertrain efficiency. A variety of proposals have been made to improve efficiency of vehicle powertrains. While providing some benefit, such proposals suffer from a number of shortcomings including those respecting adaptability, interoperability with various systems and techniques, and unrealized potential efficiency gains. There remains a significant need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art.

### SUMMARY OF THE DISCLOSURE

Example embodiments include unique apparatuses, methods, and systems including or operating an electronic control system to control operation of a vehicle. One example form of such embodiments is a method of operating an electronic control system to control operation of at least a first vehicle comprising one or more of determining a first braking distance to achieve a first target speed of the first vehicle, receiving a second vehicle braking distance to achieve a second target speed of a second vehicle forward of the first vehicle, determining a minimum following distance between the first vehicle and the second vehicle in response to the first braking distance and the second braking distance, and controlling operation of the first vehicle with an autonomous control system using the minimum following distance. Other example embodiments include unique apparatuses, methods, and systems including or operating a computer-implemented fleet management system. One example form of such embodiments is a method of operating a computer-implemented fleet management system comprising one or more of receiving logistics objectives including load, timeline, and cost information for a freight delivery, receiving fleet information including tire parameters of a plurality of vehicles of a fleet, and determining a plurality of trips and a corresponding vehicle selection in response to the logistics objectives and the fleet information. Further embodiments, forms, objects, features, advantages, aspects, and benefits shall become apparent from the following description and drawings.

### BRIEF DESCRIPTION OF THE DRAWINGS

FIG. 1 is a schematic diagram depicting certain aspects of an example vehicle system.

FIG. 2 is a schematic diagram depicting certain aspects of an example operation of the vehicle system of FIG. 1 and other vehicle systems.

FIG. 3 is a schematic diagram depicting certain aspects of example controls.

FIG. 4 is a schematic diagram depicting certain aspects of example controls

FIG. 5 is a schematic diagram depicting certain aspects of example controls

FIG. 6 is a graph illustrating fuel consumption as a function of minimum vehicle following distance for several techniques used to establish minimum vehicle following distance.

FIG. 7 is a schematic diagram depicting certain aspects of an example adaptive cruise control system.

FIG. 8 is a schematic diagram depicting certain aspects of an example fleet management system.

FIG. 9 is a schematic diagram depicting certain aspects of optimized logistics provided by a fleet management system.

### DETAILED DESCRIPTION OF EXAMPLE EMBODIMENTS

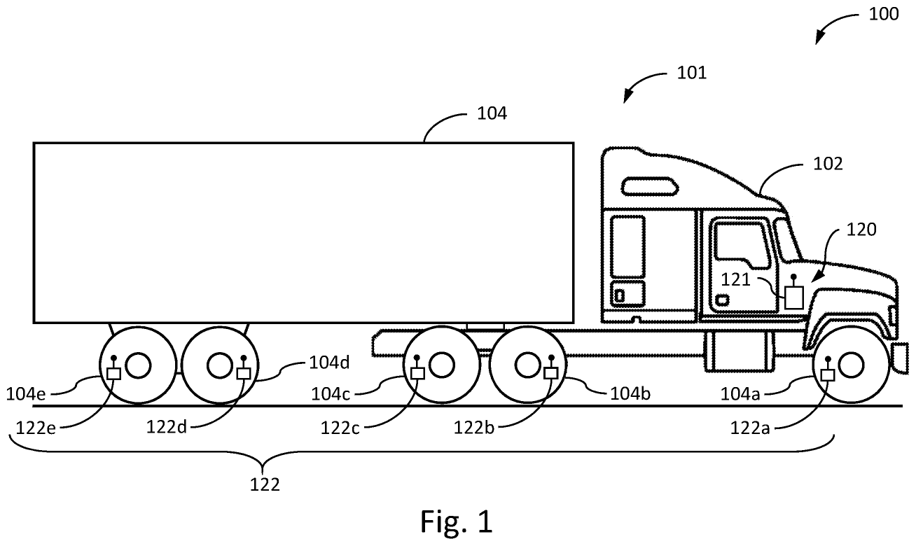

With reference to FIG. 1, there is illustrated a schematic diagram depicting certain aspects of an example vehicle system 100 comprising a vehicle 101. In the illustrated embodiment, the vehicle 101 is provided as a semi-tractor-trailer truck including a tractor unit 102 operatively coupled with and a trailer unit 104. While not visible in the illustrated view, it shall be understood that the tractor unit 102 includes a powertrain including a prime mover, such as an internal combustion engine, a transmission connected to the prime mover for adapting the output torque of the prime mover and transmitting the output torque to a driveline including drive shaft. The transmission may be an automatic transmission, an automated manual transmission, a manual transmission, or any other suitable transmission.

The tractor unit 102 includes front wheels 104a and rear wheels 104b, 104c. In the illustrated embodiment, the tractor unit 102 is provided in a rear-wheel-drive configuration in which the rear wheels 104b, 104c are driven wheels that are operatively coupled with the driveline of the powertrain and the front wheels 104a are non-drive wheels. It is contemplated that other embodiments may comprise vehicles having a front-wheel-drive configuration, an all-wheel-drive configuration, a four-wheel-drive configuration, or other configurations and forms of driven wheels. Additionally, in other embodiments, the vehicle 101 may be configured and provided as another type of vehicle such as other types of trucks, buses, passenger cars, and other types of vehicles. Furthermore, the prime mover of the vehicle 101 may comprise a number of different types of prime movers, for example, prime movers of different sizes, powers, or types (e.g., diesel engine powertrains, gasoline engine powertrains, natural gas powertrains, hybrid-electric powertrains, and electric powertrains). The trailer unit 104 includes wheels 104d, 104e.

The vehicle 101 includes an electronic control system (ECS) 120 which is structured to control and monitor a number of aspects and operations of the vehicle 101. The ECS 120 comprises one or more on-chassis control components 121 (“on-chassis controls 121”) which may comprise one or more electronic control units (ECU) and/or other control components and which may be in operative communication with one another over a communication bus or network such as one or more controller area networks (CAN). The on-chassis controls 121 may be configured to control a number of systems of the vehicle 101, for example, an engine ECU structured to control and monitor operation of an engine and engine accessories, a transmission ECU structured to control and monitor operation of a transmission, a wireless communication ECU structured to control ex-vehicle wireless communications, and one or more environmental sensor ECUs structured to control operation of an environmental sensor system may be provided.

The ECS 120 further comprises one or more off-chassis control components 122 (“off-chassis controls 122”) which may comprise one or more ECU and/or other control components and which may be in operative communication with the on-chassis controls 121 via one or more wireless communication networks. In the illustrated example, the off-chassis controls 122 comprise a plurality of tire monitoring sensor systems (TMS) 122a, 122b, 122c, 122d, 122e which are in operative communication with the on-chassis controls 121 via a wireless communication network.

The ECUs and other control components of the ECS 120 may comprise integrated circuit components, discrete circuit components, or a combination thereof. The ECUs and other control components of the ECS 120 may comprise digital circuitry, analog circuitry, or a combination thereof. The ECUs and other control components of ECS 120 can be programmable, an integrated state machine, or a combination thereof. The ECUs and other control components of the ECS 120 can include one or more Arithmetic Logic Units (ALUs), Central Processing Units (CPUs), memories, limiters, conditioners, filters, format converters, or the like which are not shown to preserve clarity. In one form, the ECS 120 is of a programmable variety that executes algorithms and processes data in accordance with operating logic that is defined by executable program instructions stored in a non-transitory memory medium (e.g., software or firmware). Alternatively or additionally, operating logic for the ECS 120 can be at least partially defined by hardwired logic or other hardware.

It shall be appreciated that the control logic and control processes disclosed herein may be performed by controllers or controls which are implemented in whole or in part in a number of computing systems, for example, in dedicated control components of the ECS 120 (e.g., in a dedicated ECU or other dedicated control circuity), in a distributed fashion across multiple control components of the ECS 120 (e.g., through coordinated operation of an engine ECU, a transmission ECU, a wireless communication ECU, and an environmental sensor ECU), in a remote computing system in operative communication with the ECS 120, such as a cloud computing system or an edge computing system in communication with one or more vehicles over a wireless communication network and configured to run a digital twin model to estimate braking distance, or in a combination of the foregoing or other computing systems.

It shall be appreciated that electronic control systems and components thereof disclosed herein may be configured to determine or obtain a parameter, quantity, value, or other operand based upon another parameter, quantity, value, or other operand in a number of manners including, for example, by calculation, computation, estimation or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof. Likewise the disclosed acts of determination or determining or obtaining a parameter, quantity, value, or other operand based upon another parameter, quantity, value, or other operand may comprise a number acts including, for example, acts of calculation, computation, estimation, or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof.

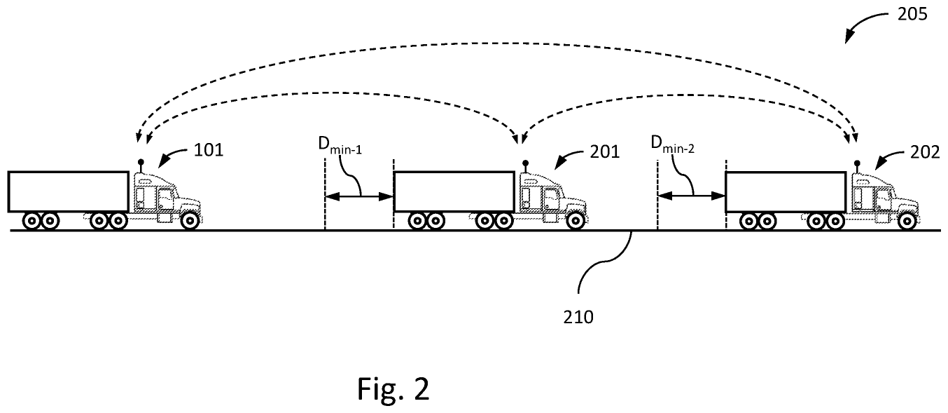

With reference to FIG. 2, there is illustrated a schematic diagram depicting the operation of the vehicle 101 in conjunction with a first forward vehicle 201 and a second forward vehicle 202 traveling along a road segment 210 of a route or mission. In the illustrated example, the first forward vehicle 201 and the second forward vehicle 202 are of substantially the same type and configuration as the vehicle 101. In other embodiments and forms, one or both of the first forward vehicle 201 and the second forward vehicle 202 may be different types of vehicles and may be differently configured.

The vehicle 101, the first forward vehicle 201, and the second forward vehicle 202 comprise a vehicle cohort 205 which could also include a greater or lesser number of two or more vehicles. The vehicles of vehicle cohort 205 may operate using any of a number of types of autonomous vehicle operation. For example, any or all of the vehicles of the vehicle cohort 205 may independently operate adaptive cruise control (ACC) or predictive cruise control (PCC) systems. Additionally or alternatively, two or more vehicles of the vehicle cohort 205 may operate together as platoon with coordinated operation. Additionally or alternatively, one or more vehicles of the vehicle cohort 205 may operate with an autonomous driving system.

The autonomous driving system may including a number of other levels of automation including, for example, level 2 partial driving automation also referred to as advanced driver assistance systems (ADAS) wherein the vehicle can control both steering and accelerating/decelerating but a human can take control of the car at any time, level 3 conditional driving automation wherein the vehicle has environmental detection capabilities and can make informed decisions for themselves, such as accelerating past a slow-moving vehicle but still require human operator intervention and control if the automation system is unable to execute a given driving task, level 4 high driving automation wherein the vehicle can operate entirely autonomously but a human operator retains the ability and option to manually override and/or the geofencing restricts vehicle operation to a limited area (e.g., an urban environment where top speeds are generally lower), or level 5 full driving automation wherein the vehicle does not have conventional operator controls (e.g., steering wheels or acceleration/braking pedals) and is free from geofencing. Additionally, the autonomous driving system may operate in an area in which traffic and traffic signal information in combination with tire connectivity information can be used to coordinate vehicle and traffic signals.

The vehicle 101 includes an electronic control system that is configured to determine a first braking distance to stop the vehicle 101 (or to achieve another non-zero target speed of the vehicle 101) while avoiding collision with the first forward vehicle 201. Similarly, the first forward vehicle 201 includes an electronic control system that is configured to determine a second braking distance to stop the first forward vehicle 201 (or to achieve another non-zero target speed of the first forward vehicle 201) while avoiding collision with the second forward vehicle 202. The second forward vehicle 202 and other vehicles of the vehicle cohort 205 (if present) may also include electronic control systems which are configured in the same or a similar manner.

As utilized herein, a vehicle braking distance refers to a braking distance to achieve a target vehicle speed, e.g., a distance required to stop a vehicle by application of vehicle brakes or to slow a vehicle to a target speed by application of vehicle brakes. In certain forms, a vehicle braking distance may be precisely defined as the distance a vehicle will travel from the point when its brakes are maximally applied to when it comes to a complete stop or another target speed. In certain forms, a vehicle braking distance may include a margin or threshold of error increasing the distance that would otherwise be required to stop a vehicle or achieve another target speed by application of vehicle brakes.

The electronic control system of the vehicle 101 is further configured to receive at least a second braking distance to stop the first forward vehicle 201 (or to achieve a non-zero target speed of the first forward vehicle 201) while avoiding collision with the second forward vehicle 202. The second braking distance may be received as a part of a vehicle-to-vehicle (V2V) basic safety message (BSM) transmitted from the first forward vehicle 201 to the vehicle 101 or a vehicle-to-X (V2X) transmission where X includes other vehicles and/or surrounding infrastructure. Similarly, the first forward vehicle 201 is further configured to receive at least a third braking distance to stop the second forward vehicle 202 (or to achieve a non-zero target speed of the second forward vehicle 202) while avoiding collision with a vehicle forward of the second forward vehicle 202. The third braking distance may be received as a part of a V2V BSM transmitted from the second forward vehicle 202 to the first forward vehicle 201. The second forward vehicle 202 and other vehicles of the vehicle cohort 205 (if present) may also include electronic control systems which are configured in the same or a similar manner. It shall be appreciated that some embodiments include a greater or lesser number of forward vehicles that the depicted in the illustrated example, for example, the second forward vehicle may not be present or a greater number of forward vehicles may be present.

The electronic control system of the vehicle 101 is further configured to determine a first minimum following distance (Dₘᵢₙ₋₁) between the vehicle 101 and the first forward vehicle 201 in response to the first braking distance and the second braking distance. The electronic control system of the vehicle 101 is further configured to determine a second minimum following distance (Dₘᵢₙ₋₁) between the first forward vehicle and the second forward vehicle in response to the second braking distance and the third braking distance. The second forward vehicle 202 and other vehicles of the vehicle cohort 205 (if present) may also include electronic control systems which are configured in the same or a similar manner.

The electronic control system of the vehicle 101 is further configured to control operation of the first vehicle with an autonomous control system using the first minimum following distance (Dₘᵢₙ₋₁). For example, the first minimum following distance (Dₘᵢₙ₋₁) may be used to set a limit on the following distance achieved by an ACC system, a PCC system, or a platooning control system. The electronic control system of the first forward vehicle 201 may be configured in the same or a similar manner with respect to the second minimum following distance (Dₘᵢₙ₋₂) and the operating parameters of the first forward vehicle 201. The second forward vehicle 202 and other vehicles of the vehicle cohort 205 (if present) may also include electronic control systems which are configured in the same or a similar manner.

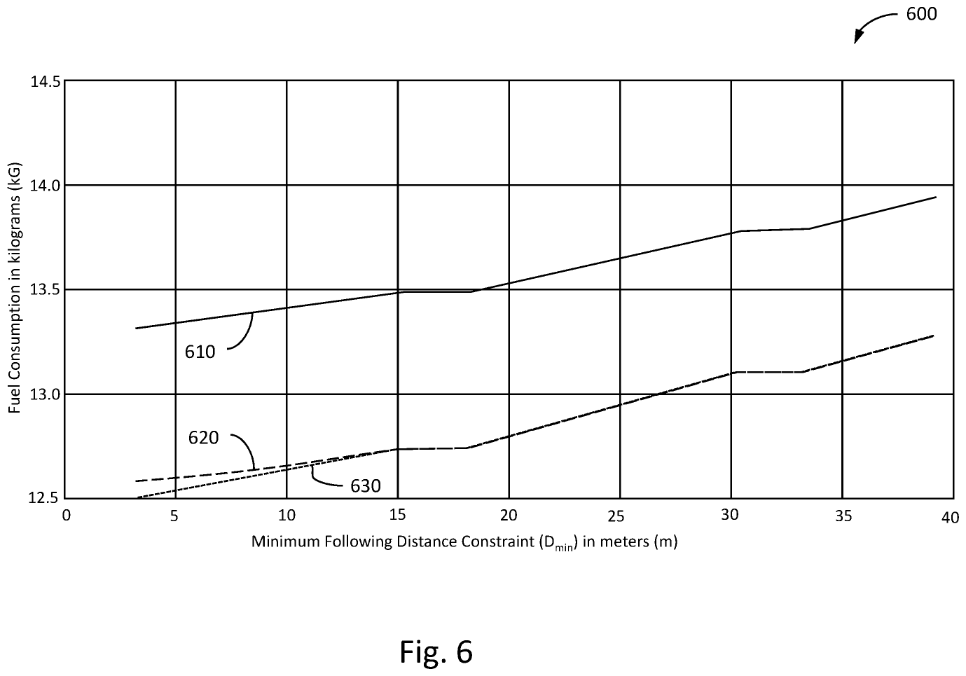

As illustrated in graph 600 of FIG. 6, the vehicle-to-vehicle minimum following distance constraint (Dₘᵢₙ) (depicted on the x-axis of graph 600) can significantly impact fuel consumption (depicted on the y-axis of graph 600). Moreover, the manner in which the vehicle-to-vehicle minimum following distance constraint (Dₘᵢₙ) is established can also significantly impact fuel consumption. For example, due to platooning operation, the fuel consumption curve 610 is about 4.4% greater than the fuel consumption curve 620 over the range 15<Dₘᵢₙ<39. Additionally, the fuel consumption curve 630 over the range 3<Dₘᵢₙ<39 is about 2% less than the fuel consumption curve 620 over the range 15<Dₘᵢₙ<39.

The electronic control system of the vehicle 101 may additionally or alternatively utilize the first minimum following distance (Dₘᵢₙ₋₁) to adjust operating parameters of the vehicle 101 in connection with an optimization of vehicle operating efficiency or fuel economy. For example, the electronic control system of the vehicle 101 may adjust (e.g., increase, decrease, calibrate, schedule, tune, or otherwise set or modify) operating parameters influencing vehicle operating efficiency or fuel economy (e.g., a drive torque, a braking torque, a torque curve, a maximum torque, an engine speed, a transmission shift point, a vehicle speed setpoints, a maximum vehicle speed, a vehicle following distance, other parameters influencing vehicle operating efficiency or fuel economy, or combinations thereof) in response to the first minimum following distance (Dₘᵢₙ₋₁) and the ability of the vehicle 101 to achieve the first minimum following distance (Dₘᵢₙ₋₁) under current settings of such operating parameters. The electronic control system of the first forward vehicle 201 may be configured in the same or a similar manner with respect to the second minimum following distance (Dₘᵢₙ₋₂) and the operating parameters of the first forward vehicle 201. The second forward vehicle 202 and other vehicles of the vehicle cohort 205 (if present) may also include electronic control systems which are configured in the same or a similar manner.

While certain aspects of FIG. 2 are described in terms of an apparatus or system, it shall be appreciated that any or all of the vehicle 101, the first forward vehicle 201, and the second forward vehicle 202, may perform a method of operating their respective electronic control system including determining a first braking distance to stop the vehicle (or to achieve a non-zero target speed of the vehicle), receiving a second vehicle braking distance to stop a second vehicle forward of the first vehicle (or to achieve a non-zero target speed of the second vehicle), determining a minimum following distance between the first vehicle and the second vehicle in response to the first braking distance and the second braking distance, and controlling operation of the vehicle with an autonomous control system using the minimum following distance.

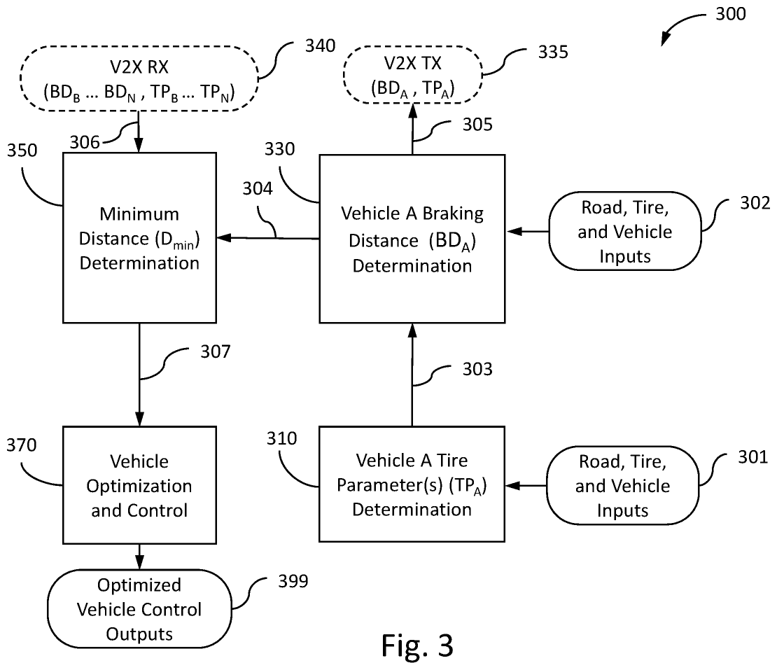

With reference to FIG. 3, there is illustrated a schematic diagram depicting certain aspects of example controls 300 which may be implemented and executed in whole or in part in an electronic control system associated with a vehicle, for example, ECS 120 of the vehicle 101, an ECS of the first forward vehicle 201, an ECS of the second forward vehicle 202, or another electronic control system associated with a vehicle. Controls 300 include operators 310, 330, 350, and 370 which may comprise components of the on-chassis controls 121 of the vehicle 101, the off-chassis controls 122 of the vehicle 101, or a combination thereof. As noted above, the first forward vehicle 201 and the second forward vehicle 202 may include controls that are the same as or are substantially similar to controls 300.

Operator 310 receives a plurality of inputs 301 and, in response to the plurality of inputs 301, determines and outputs one or more tire parameters (TP_{A}) 303 for one or more tires of a given vehicle. The plurality of inputs 301 may comprise inputs relating to road characteristics and conditions, tire characteristics and conditions, and vehicle characteristics and conditions. The one or more tire parameters (TP_{A}) may comprise at least one coefficient of friction (μ) for one or more tires and the road as well as other parameters, for example, tire rolling resistance and/or lateral stability parameters. In certain forms, the operator 310 may determine the least one coefficient of friction (μ) and/or tire parameters (TP_{A}) based upon an empirically determined model and/or a parameterized model such as a parameterized model based on Pacejka's Magic Formula, sometimes referred to as Pacejka's Magical Formula, the Magic Formula, or the Magical Formula, including any of a number of adaptations, applications, extensions, implementations, and variations thereof as will occur to one of skill in the art with the benefit of the present disclosure (a “PMF model”).

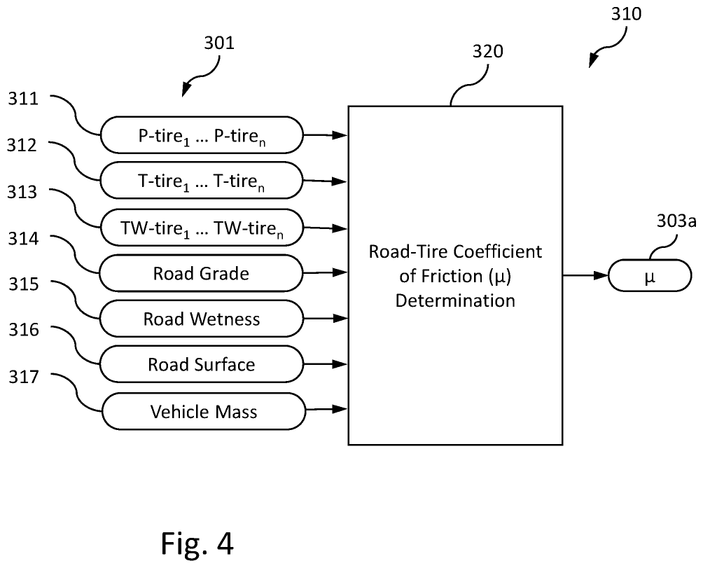

As illustrated in FIG. 4, for example, operator 310 may comprise utilize multi-dimensional lookup table 320 which receives inputs 301 that may include pressure values for one or more tires (P-tire₁ . . . P-tireₙ) 311, temperature values for one or more tires (T-tire₁ . . . T-tireₙ) 312, tread wear values for one or more tires (TW-tire₁ . . . TW-tireₙ) 313, a road grade value 314, a road wetness value 315, a road surface value 316, and a vehicle mass value 317. In response to the received inputs 301, the multi-dimensional lookup table 320 determines and the least one coefficient of friction (μ) and provides the same as output 303a. An output vector of the least one coefficient of friction (μ)of the multi-dimensional lookup table 320 may be predetermined using an empirically determined model, a parameterized model such as a model based on a PMF model, or a combination thereof. While more computationally intensive, it is also contemplated that the operator 310 could dynamically calculate, estimate or otherwise compute or determine the least one coefficient of friction (μ) using one or more dynamically executed operations such as operations to determine parameters using a PMF model.

The operator 330 receives the one or more tire parameters (TP_{A}) 303 and a plurality of inputs 302 and, in response thereto, determines a vehicle braking distance (BD_{A}). Operator 330 may determine the vehicle braking distance (BD_{A}) using a number of techniques. In certain forms, the operator 330 may determine vehicle braking distance (BD_{A}) in accordance with the equation:

BD_{A}=V²/(2g(μ+G))

where V is vehicle velocity, g is acceleration due to gravity, μ is a coefficient of friction between the tires and the road (e.g., the least one coefficient of friction value of output 303a), and G is percent road grade. In other forms, the operator 330 may determine vehicle braking distance (BD_{A}) in accordance with other equations as will occur to one of skill in the art with the benefit of the present disclosure. Other embodiments may utilize other techniques to determine a vehicle braking distance (BD_{A}) including, for example, determination in accordance with other equations or a simulation or model such as a digital twin model of vehicle operation.

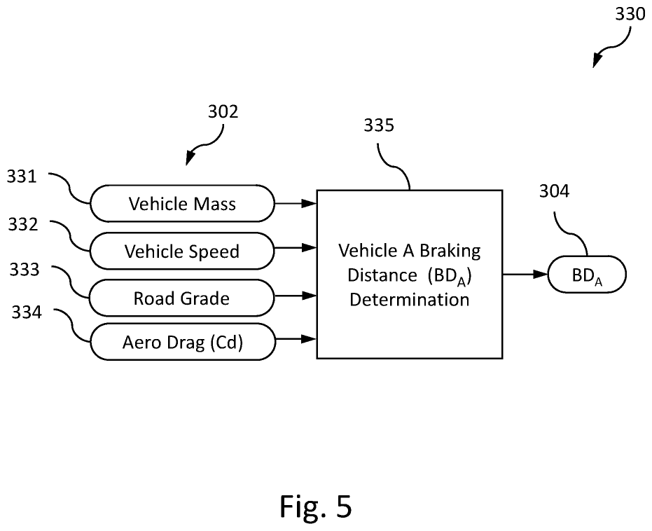

The operator 330 may determine the vehicle braking distance (BD_{A}) using a lookup table. As illustrated in FIG. 5, for example, operator 330 may comprise utilize multi-dimensional lookup table 335 which receives inputs 302 that may include a vehicle mass value 331, a vehicle speed value 332, a road grade value 333, and a coefficient of aerodynamic drag (Cd) value 334. In response to the received inputs 302, the multi-dimensional lookup table 335 determines a vehicle braking distance value (BD_{A}) 304.

The operator 330 provides the vehicle braking distance value (BD_{A}) as an output 304 to operator 350. The operator 330 also provides an output 305 of the vehicle braking distance value (BD_{A}) (and optionally the one or more tire parameters (TP_{A})) to other vehicles, for example as a V2V BSM or another type of transmission or message.

An output vector of the vehicle braking distance (BD_{A}) of the multi-dimensional lookup table 335 may be predetermined using an empirically determined model, formula-based model such as disclosed hereinabove, or a combination thereof. While more computationally intensive, it is also contemplated that the operator 330 could dynamically calculate, estimate or otherwise compute or determine the vehicle braking distance value (BD_{A}) using one or more dynamically executed operations such as operations implementing a formula based model such as disclosed hereinabove.

The operator 350 receives the vehicle braking distance value (BD_{A}) and one or more values 306 which comprise vehicle braking distances (BD_{B} . . . BD_{N}) for one or more forward vehicles and may optionally comprise tire parameters (TP_{B} . . . TP_{N}) for one or more forward vehicles. In response to these inputs, the operator 350 determines a minimum vehicle following distance (Dₘᵢₙ) The operator 350 may determine the minimum vehicle following distance (Dₘᵢₙ) in accordance with the equation:

$$\begin{matrix}{D}_{min} = {BD}_{A} - {BD}_{A + 1} + {δ}_{ms} for {BD}_{A} > {BD}_{A + 1} \\ = {δ}_{ms} for {BD}_{A} < {BD}_{A + 1}\end{matrix}$$

where BDA is the vehicle braking distance for a given vehicle, BD_{A+1} is the vehicle braking distance for a vehicle immediately forward of the given vehicle, and δₘₛ is a margin of safety accounting for one or more of operator reaction time, electronic control system response time, and an additional safety margin greater than or equal to an absolute minimum distance.

The operator 350 provides the minimum vehicle following distance (Dₘᵢₙ) as an output 307 which is received as an input by operator 370. In response to the received input, the operator 370 adjusts (e.g., increase, decrease, calibrate, schedule, tune, or otherwise set or modify) operating parameters influencing vehicle operating efficiency or fuel economy (e.g., a drive torque, a braking torque, a torque curve, a maximum torque, an engine speed, a transmission shift point, a vehicle speed setpoints, a maximum vehicle speed, a vehicle following distance, other parameters influencing vehicle operating efficiency or fuel economy, or combinations thereof) in response to the first minimum following distance (Dₘᵢₙ) and the ability of the vehicle to achieve the first minimum following distance (Dₘᵢₙ) under current settings of such operating parameters. In turn, the adjusted operating parameters influencing vehicle operating efficiency or fuel economy are translated into vehicle operating commands, e.g., fueling, braking, transmission shifting, engine speed, or other operating commands 399 which are used in controlling operating of the vehicle.

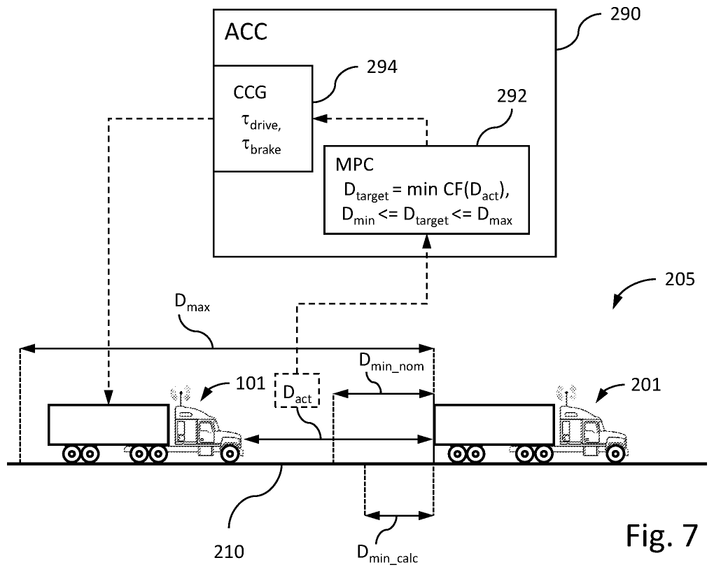

In some embodiments, operator 370 may comprise or may call or trigger operation of an automated driving system including a model predictive controller. For, example, with reference to FIG. 7, there is illustrated an example adaptive cruise control (ACC) system 290 including a model predictive controller (MPC) 292 and cruise command generator (CCG) 294. The MPC 292 is configured to determine a target following distance (D_{target}) between the vehicle 101 and the first forward vehicle 201 that minimizes a defined cost function (CF) such as fuel consumption subject to a maximum distance constraint (Dₘₐₓ) a minimum distance constraint (Dₘᵢₙ). The MPC 292 may perform this optimization using a dynamic model of the vehicle and powertrain to predict vehicle response such as speed and distance. The CCG 294 is configured to determine drive torque (τ_{drive}) and/or braking torque (τ_{brake}) to achieve the target following distance (D_{target}).

During operation, the ACC system 290 adjusts the distance between the vehicle 101 and the first forward vehicle 201 (Dart) in accordance with the target following distance (D_{target}) to provide powertrain operation optimized according to the cost function of the MPC 292. The effect of the ACC system 290 and the MPC 292 may be to increase fuel economy, for example, by adjusting vehicle-to-vehicle distance in a manner that voids avoid aggressive acceleration/deceleration subject to the Dₘₐₓ and Dₘᵢₙ constraints. The MPC 292 is provided with a minimum following distance (D_{min_calc}) calculated in accordance with the techniques disclosed herein, for example, as described in connection with operator 350. The minimum following distance (D_{min_calc}) is less than a nominal minimum following distance (D_{min_nom}) which is based on a more conservative assumption or determined in a less accurate manner (e.g., a predetermined minimum distance, a minimum, distance dynamically determine using a technique limited to consideration of stopping the vehicle itself or that fails to account for the braking capabilities of the first forward vehicle 201, or another more conservative minimum distance). The provision of the first calculated minimum following (D_{min_calc}) provides a greater range of distance and a larger optimization space in which the MPC 292 can operate and enhances operation of the MPC 292 and the fuel economy that is realized by operation of the ACC system 290.

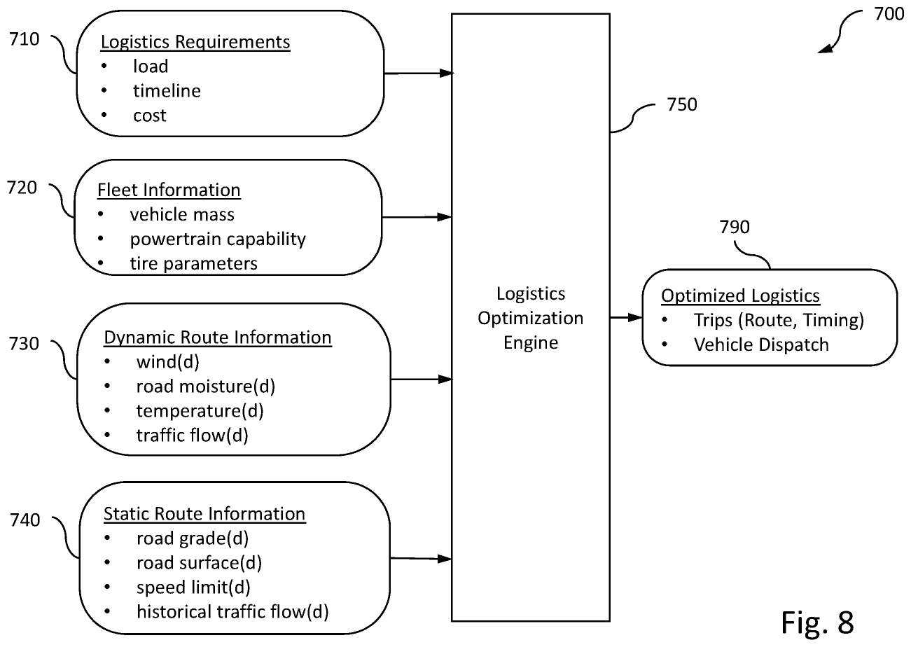

With reference to FIG. 8, there is illustrated an example fleet management system 700 which may be implemented in one or more computing systems, for example, in a cloud-based computing system, an edge-based computing system, or one or more workstations or on-premises servers. The fleet management system 700 includes a logistics optimization engine (LOE) 750 which is configured to determine optimized logistics 790 in response to a plurality of resources, including logistics requirements 710, fleet information 720, dynamic route information 730, and static route information 740, which may be either received as inputs or accessed, queried, or otherwise obtained by the LOE 750.

In the illustrated embodiment, the logistics requirements 710 comprise load information (e.g., mass, volume, dimensions for each item or divisible sub-unit of a load to be delivered), timeline information (e.g., a target delivery time for each item or divisible sub-unit of a load to be delivered), and cost information (e.g., costs associated with delay of a target delivery time for each item or divisible sub-unit of a load to be delivered or cost objectives or targets for completion of the logistics or a portion thereof). In other embodiments, the logistics requirements 710 may comprise additional and/or alternative information as will occur to one of skill in the art with the benefit of the present disclosure.

In the illustrated embodiment, the fleet information 720 comprise vehicle mass (e.g., the unloaded mass of each vehicle in a fleet), powertrain capability (e.g., torque ratings or curves, horsepower ratings or curves and the like for each vehicle in a fleet), and tire parameters (e.g., such as a coefficient of friction (μ) for one or more tires, information from which the coefficient of friction (μ) can be determined, or other tire parameter information disclose herein or which will occur one of skill in the art with the benefit of the present disclosure). In other embodiments, the fleet information 720 may comprise additional and/or alternative information as will occur to one of skill in the art with the benefit of the present disclosure.

In the illustrated embodiment, the dynamic route information 730 comprise wind speed and direction as a function of route distance or location (wind(d)), road moisture or wetness as a function of route distance or location (road moisture(d)), ambient and/or road temperature information as a function of route distance or location (temperature(d)), and traffic flow information as a function of route distance or location (traffic flow(d)). In other embodiments, the dynamic route information 730 may comprise additional and/or alternative information as will occur to one of skill in the art with the benefit of the present disclosure.

In the illustrated embodiment, the static route information 740 comprises road grade as a function of route distance or location (road grade(d)), road surface type or friction coefficient as a function of route distance or location (road surface(d)), posted or legal speed limit information as a function of route distance or location (speed limit(d)), and historical or averaged traffic flow or speed information as a function of route distance or location (historical traffic speed(d)). In other embodiments, the static route information 740 may comprise additional and/or alternative information as will occur to one of skill in the art with the benefit of the present disclosure.

The LOE 750 is configured to perform an optimization in response to logistics requirements 710, fleet information 720, dynamic route information 730, and static route information 740 to determine the optimized logistics 790. In certain embodiments, the LOE 750 is configured to run a plurality of simulations using an MPC or other optimization controller to optimize a cost function (e.g., fuel economy, delivery time, or a combination thereof) in response to logistics requirements 710, fleet information 720, dynamic route information 730, and static route information 740 to determine the optimized logistics 790. Such simulations can account for the aforementioned vehicle mass, powertrain capability, tire parameters, wind speed and direction, road moisture or wetness, ambient and/or road temperature, traffic flow, road grade, road surface type or friction coefficient, posted or legal speed limit, historical or averaged traffic flow or speed, and other information as will occur to one of skill in the art with the benefit of the present disclosure.

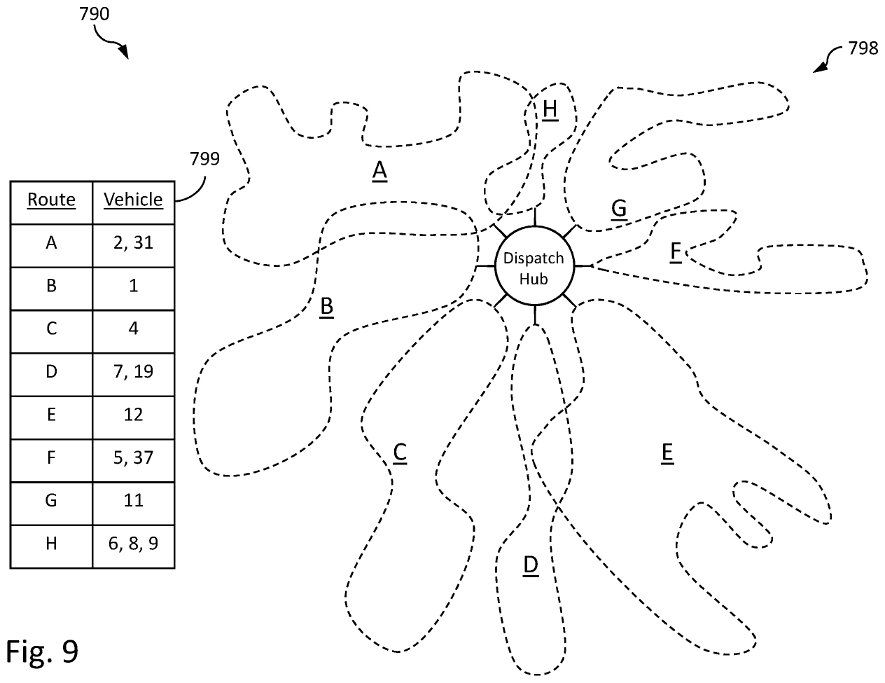

The LOE 750 is configured to output optimized logistics 790 from the optimization which it performs. As illustrated in FIG. 9, the optimized logistics 790 include information of a plurality of trips 798 A-H each of which comprises route or positional information and timing information. The optimized logistics 790 also include vehicle dispatch information 799 which assigns or associates one or more particular vehicles of a fleet with the plurality of trips.

It shall be appreciated that the present disclosure contemplates a number of example embodiments. A first example embodiment is a method of operating an electronic control system to control operation of at least a first vehicle, the method comprising: determining a first braking distance to achieve a first target speed of the first vehicle; receiving a second vehicle braking distance to achieve a second target speed of a second vehicle forward of the first vehicle; determining a minimum following distance between the first vehicle and the second vehicle in response to the first braking distance and the second braking distance; and controlling operation of the first vehicle with an autonomous control system using the minimum following distance.

A second example embodiment includes the features of the first example embodiment, wherein at least one of: the act of determining a first braking distance utilizes one or more tire parameters of the first vehicle, and the act of determining a second braking distance utilizes one or more tire parameters of the second vehicle.

A third example embodiment includes the features of the second example embodiment, wherein at least one of: the one or more tire parameters of the first vehicle comprise one or more coefficients of friction, and the one or more tire parameters of the second vehicle comprise one or more coefficients of friction.

A fourth example embodiment includes the features of any of the first example embodiment, the second example embodiment, or the third example embodiment, wherein the act of determining the first braking distance utilizes at least one of an empirically determined model and a parameterized model.

A fifth example embodiment includes the features of the fourth example embodiment, wherein at least one of the empirically determined model and the parameterized model comprises a PMF model.

A sixth example embodiment includes the features of any of the first example embodiment, the second example embodiment, or the third example embodiment, wherein the act of receiving a second vehicle braking distance comprises one or more of: receiving a vehicle to vehicle transmission from the second vehicle to the first vehicle, receiving a vehicle to infrastructure transmission from the second vehicle to a computing system remote from the second vehicle and the first vehicle, and receiving a vehicle to infrastructure transmission from the to the first vehicle.

A seventh example embodiment includes the features of any of the first example embodiment, the second example embodiment, or the third example embodiment, wherein the act of determining a minimum following distance between the first vehicle and the second vehicle in response to the first braking distance and the second braking distance comprises comparing the first braking distance and the second braking distance.

An eighth example embodiment includes the features of any of the first example embodiment, the second example embodiment, or the third example embodiment, wherein the act of controlling operation of the first vehicle with an autonomous control system using the minimum following distance comprises operating at least one of a predictive cruise control system, an adaptive cruise control system, a platoon control system, and a model predictive controller using the minimum following distance.

A ninth example embodiment includes the features of any of the first example embodiment, the second example embodiment, or the third example embodiment, wherein one or both of: the first target speed of the first vehicle is a zero or stopped speed the first vehicle, and the second target speed of the second vehicle is a zero or stopped speed the second vehicle.

A tenth example embodiment is a vehicle system comprising: an electronic control system configured to: determine a first braking distance to achieve a first target speed of a first vehicle, receive a second vehicle braking distance to achieve a second target speed of a second vehicle forward of the first vehicle, determine a minimum following distance between the first vehicle and the second vehicle in response to the first braking distance and the second braking distance, and control operation of the first vehicle with an autonomous control system using the minimum following distance.

An eleventh example embodiment includes the features of the tenth example embodiment, wherein the electronic control system is configured to at last one of: determine the first braking distance in response to one or more tire parameters of the first vehicle, and determine the second braking distance in response to one or more tire parameters of the second vehicle.

A twelfth example embodiment includes the features of the eleventh example embodiment, wherein at least one of: the one or more tire parameters of the first vehicle comprise one or more coefficients of friction, and the one or more tire parameters of the second vehicle comprise one or more coefficients of friction.

A thirteenth example embodiment includes the features of any of the tenth example embodiment, the eleventh example embodiment, or the twelfth example embodiment, wherein the electronic control system is configured to determine the first braking distance using at least one of an empirically determined model and a parameterized model.

A fourteenth example embodiment includes the features of the thirteenth example embodiment, wherein at least one of the empirically determined model and the parameterized model comprises a PMF model.

A fifteenth example embodiment includes the features of any of the tenth example embodiment, the eleventh example embodiment, or the twelfth example embodiment, wherein the electronic control system is configured to receive a second vehicle braking distance comprises one or more of: receiving a vehicle to vehicle transmission from the second vehicle to the first vehicle, receiving a vehicle to infrastructure transmission from the second vehicle to a computing system remote from the second vehicle and the first vehicle, and receiving a vehicle to infrastructure transmission from the to the first vehicle.

A sixteenth example embodiment includes the features of any of the tenth example embodiment, the eleventh example embodiment, or the twelfth example embodiment, wherein the electronic control system is configured to determine a minimum following distance between the first vehicle and the second vehicle in response to the first braking distance and the second braking distance at least in part by comparing the first braking distance and the second braking distance.

A seventeenth example embodiment includes the features of any of the tenth example embodiment, the eleventh example embodiment, or the twelfth example embodiment, wherein the electronic control system is configured to control operation of the vehicle with an autonomous control system using the minimum following distance comprises operating at least one of a predictive cruise control system, an adaptive cruise control system, a platoon control system, and a model predictive controller using the minimum following distance.

An eighteenth example embodiment includes the features of any of the tenth example embodiment, the eleventh example embodiment, or the twelfth example embodiment, wherein one or both of: the first target speed of the first vehicle is a zero or stopped speed the first vehicle, and the second target speed of the second vehicle is a zero or stopped speed the second vehicle.

A nineteenth example embodiment is a method of operating a computer-implemented fleet management system, the method comprising: receiving logistics objectives including load, timeline, and cost information for a freight delivery; receiving fleet information including tire parameters of a plurality of vehicles of a fleet; and determining a plurality of trips and a corresponding vehicle selection in response to the logistics objectives and the fleet information.

A twentieth example embodiment is a computer-implemented fleet management system configured to: receive logistics objectives including load, timeline, and cost information for a freight delivery; receive fleet information including tire parameters of a plurality of vehicles of a fleet; and determine a plurality of trips and a corresponding vehicle selection in response to the logistics objectives and the fleet information.

While example embodiments of the disclosure have been illustrated and described in detail in the drawings and foregoing description, the same is to be considered as examples and not restrictive in character, it being understood that only certain example embodiments have been shown and described and that all changes and modifications that come within the spirit of the claimed inventions are desired to be protected. It should be understood that while the use of words such as preferable, preferably, preferred, or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of operating an electronic control system to control operation of at least a first vehicle, the method comprising:
determining a first braking distance to achieve a first target speed of the first vehicle; receiving a second vehicle braking distance to achieve a second target speed of a second vehicle forward of the first vehicle;
determining a minimum following distance between the first vehicle and the second vehicle in response to the first braking distance and the second braking distance; and
controlling operation of the first vehicle with an autonomous control system using the minimum following distance.

2. The method of claim 1 wherein at least one of: the act of determining a first braking distance utilizes one or more tire parameters of the first vehicle, and the act of determining a second braking distance utilizes one or more tire parameters of the second vehicle.

3. The method of claim 2 wherein at least one of: the one or more tire parameters of the first vehicle comprise one or more coefficients of friction, and the one or more tire parameters of the second vehicle comprise one or more coefficients of friction.

4. The method of claim 1 wherein the act of determining the first braking distance utilizes at least one of an empirically determined model and a parameterized model.

5. The method of claim 4 wherein at least one of the empirically determined model and the parameterized model comprises a PMF model.

6. The method of claim 1 wherein the act of receiving a second vehicle braking distance comprises one or more of: receiving a vehicle to vehicle transmission from the second vehicle to the first vehicle, receiving a vehicle to infrastructure transmission from the second vehicle to a computing system remote from the second vehicle and the first vehicle, and receiving a vehicle to infrastructure transmission from the to the first vehicle.

7. The method of claim 1 wherein the act of determining a minimum following distance between the first vehicle and the second vehicle in response to the first braking distance and the second braking distance comprises comparing the first braking distance and the second braking distance.

8. The method of claim 1 wherein the act of controlling operation of the first vehicle with an autonomous control system using the minimum following distance comprises operating at least one of a predictive cruise control system, an adaptive cruise control system, a platoon control system, and a model predictive controller using the minimum following distance.

9. The method of claim 1 wherein one or both of: the first target speed of the first vehicle is a zero or stopped speed the first vehicle, and the second target speed of the second vehicle is a zero or stopped speed the second vehicle.

10. A vehicle system comprising:
an electronic control system configured to:
determine a first braking distance to achieve a first target speed of a first vehicle, receive a second vehicle braking distance to achieve a second target speed of a second vehicle forward of the first vehicle,
determine a minimum following distance between the first vehicle and the second vehicle in response to the first braking distance and the second braking distance, and
control operation of the first vehicle with an autonomous control system using the minimum following distance.

11. The vehicle system of claim 10 wherein the electronic control system is configured to at last one of: determine the first braking distance in response to one or more tire parameters of the first vehicle, and determine the second braking distance in response to one or more tire parameters of the second vehicle.

12. The vehicle system of claim 11 wherein at least one of: the one or more tire parameters of the first vehicle comprise one or more coefficients of friction, and the one or more tire parameters of the second vehicle comprise one or more coefficients of friction.

13. The vehicle system of claim 10 wherein the electronic control system is configured to determine the first braking distance using at least one of an empirically determined model and a parameterized model.

14. The vehicle system of claim 13 wherein at least one of the empirically determined model and the parameterized model comprises a PMF model.

15. The vehicle system of claim 10 wherein the electronic control system is configured to receive a second vehicle braking distance comprises one or more of: receiving a vehicle to vehicle transmission from the second vehicle to the first vehicle, receiving a vehicle to infrastructure transmission from the second vehicle to a computing system remote from the second vehicle and the first vehicle, and receiving a vehicle to infrastructure transmission from the to the first vehicle.

16. The vehicle system of claim 10 wherein the electronic control system is configured to determine a minimum following distance between the first vehicle and the second vehicle in response to the first braking distance and the second braking distance at least in part by comparing the first braking distance and the second braking distance.

17. The vehicle system of claim 10 wherein the electronic control system is configured to control operation of the vehicle with an autonomous control system using the minimum following distance comprises operating at least one of a predictive cruise control system, an adaptive cruise control system, a platoon control system, and a model predictive controller using the minimum following distance.

18. The vehicle system of claim 10 wherein one or both of: the first target speed of the first vehicle is a zero or stopped speed the first vehicle, and the second target speed of the second vehicle is a zero or stopped speed the second vehicle.

19. A method of operating a computer-implemented fleet management system, the method comprising:
receiving logistics objectives including load, timeline, and cost information for a freight delivery;
receiving fleet information including tire parameters of a plurality of vehicles of a fleet; and
determining a plurality of trips and a corresponding vehicle selection in response to the logistics objectives and the fleet information.

20. (canceled)
